(19) United States
(12) Patent Application Publication
(10) Pub. No.: US 2011/0225860 A1
(43) Pub. Date: Sep. 22, 2011

(54) Copy Raising, Lowering and Tensioning System for a Billboard

(76) Inventors: Thomas P. Troiano, Sycamore, OH (US); Zeile Klaiss, Bettsville, OH (US)

(21) Appl. No.: 13/044,805

(22) Filed: Mar. 10, 2011

Related U.S. Application Data
(60) Provisional application No. 61/340,357, filed on Mar. 16, 2010.

(51) Int. Cl. G09F 7/00; G09F 15/02

(52) U.S. Cl. 40/601; 40/624

(57) ABSTRACT

A billboard system has a framework supporting at least one panel. A lower rail is fixed to the framework and has at least one downwardly opening channel. An upper rail is movable with respect to the framework. The upper rail has at least one upwardly opening channel. A billboard copy at least partially covers the at least one panel. Rods may be selectively located in the copy. Steps for tensioning the copy are also disclosed.

### RELATED APPLICATION

This application claims the benefit from U.S. patent application Ser. No. 61/340,357 filed on Mar. 16, 2010, which is fully incorporated by reference herein.

### FIELD OF THE INVENTION

The present invention relates to a system for raising and lowering copy on a billboard and for applying tension to the copy when it is raised.

### BACKGROUND OF THE INVENTION

Billboard systems are well known structures used in advertising and marketing. These systems can be a variety of sizes and shapes, and they can be put into a wide variety of locations, but generally, they all work in the same manner to display the desired picture and/or message. For example, most billboard systems comprise a framework that supports one or more panels onto which advertising/marketing material can be located.

Typically, the advertising/marketing material, called copy, is used for a certain amount of time. Then, for a wide variety of reasons, it is desirable to remove or replace one installed copy with another. The known billboard systems suffer from many disadvantages associated with this process.

For example, often billboard systems are located off the ground, some to a great degree. This height, or other physical issues, can make it very difficult, dangerous and time consuming for workers. The other problem with known billboard systems is that because of these same physical issues, it can take several workers to remove an old copy and install new copy. The number of workers increases the risk of accidents, and it costs the employer of the workers greater sums to employ a team of workers each time work on a billboard system is required.

Of course, the copy needs to look professional and neat when installed on any billboard. However, known billboard systems can make this difficult as wrinkles, misaligned copy and installation mistakes can make the advertised message unappealing to consumers.

Further, on some billboard systems, the copy is comprised of a plurality of sheets which must be transported and correctly installed. The number of sheets adds to the complexity and costs of an installation. Additionally, if the sheets have been installed with an adhesive, the adhesive may make them difficult to remove and recycle.

In view of the disadvantages of the known prior art billboard systems, it would be advantageous to have a system that was easy to install, regardless of location, with a minimum number of workers. It would also be advantageous for a system to have a cost effective and easy to use system for ensuring the copy was accurately and professionally displayed. Further, it would be advantageous for a system to utilizing a minimum number of copy sheets and for the copy material to be recyclable.

### BRIEF DESCRIPTION OF THE DRAWINGS

The advantages of the present invention will become readily apparent to those skilled in the art from the following detailed description when considered in the light of the accompanying drawings in which:

FIG. 1 is a front view of one embodiment of a billboard system;

FIG. 2 is a partial perspective view depicting a support arm on a lower rail receiving copy, an upper rail is located adjacent the lower rail;

FIG. 3 is a partial perspective view of the support arm and copy thereon;

FIG. 4 is a partial front view of a pipe being inserted into an upper pocket of the copy;

FIG. 5 is a partial front view of a pipe being inserted into a lower pocket of the copy;

FIG. 6 is partial perspective view of a pipe and copy being located in a channel of the upper rail;

FIG. 7 is a partial perspective view of the pipe and copy located in the channel of the upper rail;

FIG. 8 is a partial perspective view of the support arm being pivotable with respect to the lower rail;

FIG. 9 is a partial perspective view of the support arm, the lower rail, and the pipe and the copy located in the lower rail;

FIG. 10 is a partial perspective view of an upper corner of the system depicting a slide block and a pulley with a cable extending along a panel, through the slide block and around the pulley;

FIG. 11 is a partial perspective view of a rear side of the billboard system including a rail leveler, a latching system and a winch system;

FIG. 12 is a partial perspective view of a detail of the rail leveler and latching system;

FIG. 13 is a top view of the rail leveler and latching system;

FIG. 14 is a view of the rail leveler and latching system in a first condition as seen from line 14-14 of FIG. 13;

FIG. 15 is a view of the rail leveler and latching system in a second condition as seen from line 14-14 in FIG. 13;

FIG. 16 is a top view of the rail leveler;

FIG. 17 is a side view of the rail leveler;

FIG. 18 is a partial front view of the billboard system depicting one side tensioning system;

FIG. 19 is a partial side view of the billboard system depicting the side tensioning system of FIG. 18;

FIG. 20 is a detail of a clamp for a side tensioning system of FIG. 21;

FIG. 21 is a partial side view of the tensioning system with the clamp of FIG. 20;

FIG. 22 is a partial side view of another side tensioning system;

FIG. 23 is a partial perspective view of a component of the side tensioning system of FIG. 22; and

FIG. 24 is a flow chart for one method of using the system.

### SUMMARY OF THE INVENTION

In one embodiment, a billboard system comprises a framework supporting at least one panel. A lower rail is fixed to a lower portion of the framework and extends across the panel. The lower rail has at least one downwardly opening channel. An upper rail is movable with respect to the framework and it extends across the panel. The upper rail has at least one upwardly opening channel. At least one tab is provided on both the lower rail and the upper rail. The tab is selectively pivotable between a forward facing position and a side facing position at least partially across the channels.

In another embodiment, the lower rail has an upper surface, an outer surface, a lower surface and a rear surface. The channel is located in the lower surface. The upper rail has an upper surface, an outer surface, a lower surface and a rear surface. The channel is located in the upper surface. A billboard copy at least partially covers the at least one panel. The copy has an upper portion, a lower portion and at least one side portion. The upper portion and the lower portion each selectively receive at least one rod. The upper and lower portions and the rods are selectively located within the respective channels so that the copy extends across the outer surfaces of the respective rails.

In another embodiment, the billboard system comprises a framework supporting the at least one panel and a cable extending along the panel. The at least one side portion of the copy selectively receives at least two rods. A side portion tensioning system is provided with a rod block slidably mounted on at least one block slide. The block slide is biased by at least one spring on the block slide.

Yet another embodiment is a billboard tensioning system comprising the steps of providing at least one billboard panel with at least one side portion. An at least one side portion of a billboard copy is connected to at least two side rods. At least one upper rail rod is located in an upper rail channel and at least one lower rail rod is located in a lower rail channel. The billboard copy is connected to both the upper rail rod and the lower rail rod. The upper rail channel is raised with a cable to add vertical tension to the billboard copy. The at least two side rods connected to the billboard copy are drawn toward the billboard panel side portion to add horizontal tension to the billboard copy.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts. Hence, specific dimensions, directions or other physical characteristics relating to the embodiments disclosed are not to be considered as limiting, unless expressly stated otherwise.

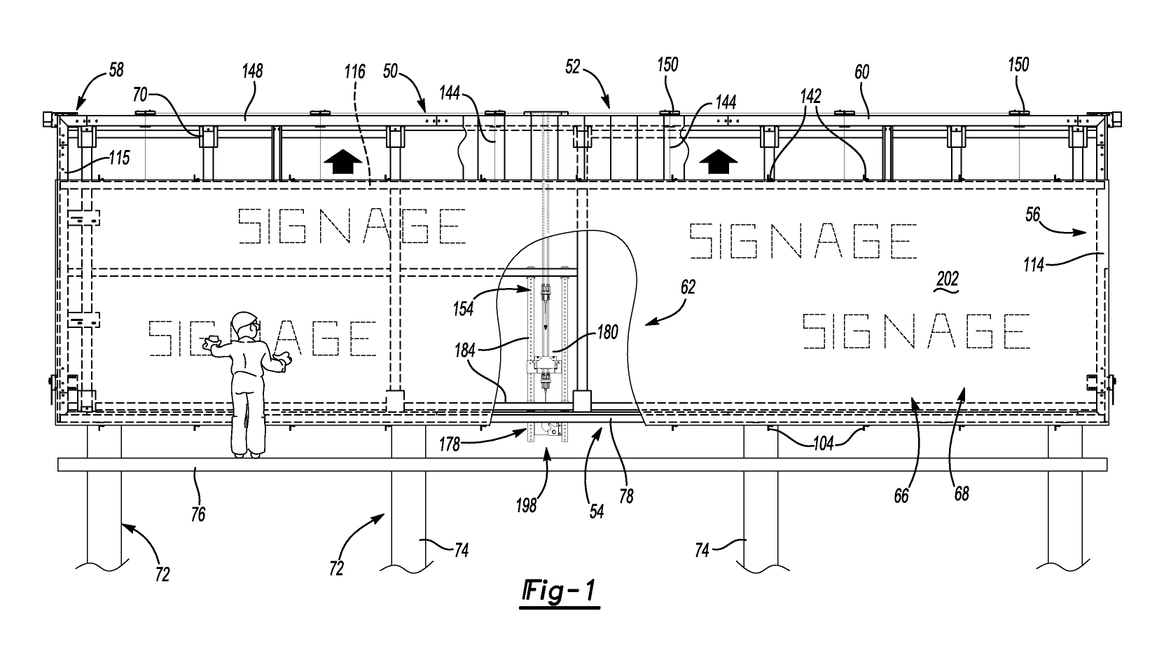

Turning now to FIG. 1, one embodiment of a billboard system 50 is depicted. In this embodiment, the billboard system 50 comprises an upper portion 52, a lower portion 54, a first side portion 56 and a second side portion 58. The upper and lower portions 52, 54 are substantially parallel to one another and the side portions 56, 58 are substantially parallel to one another. The upper and lower portions 52, 54 are substantially perpendicular to the side portions 56, 58.

The foregoing portions 52-58 describe a substantially rectangular perimeter 60 of the system 50. However, other geometric shapes, such as square or any other polygon may be used.

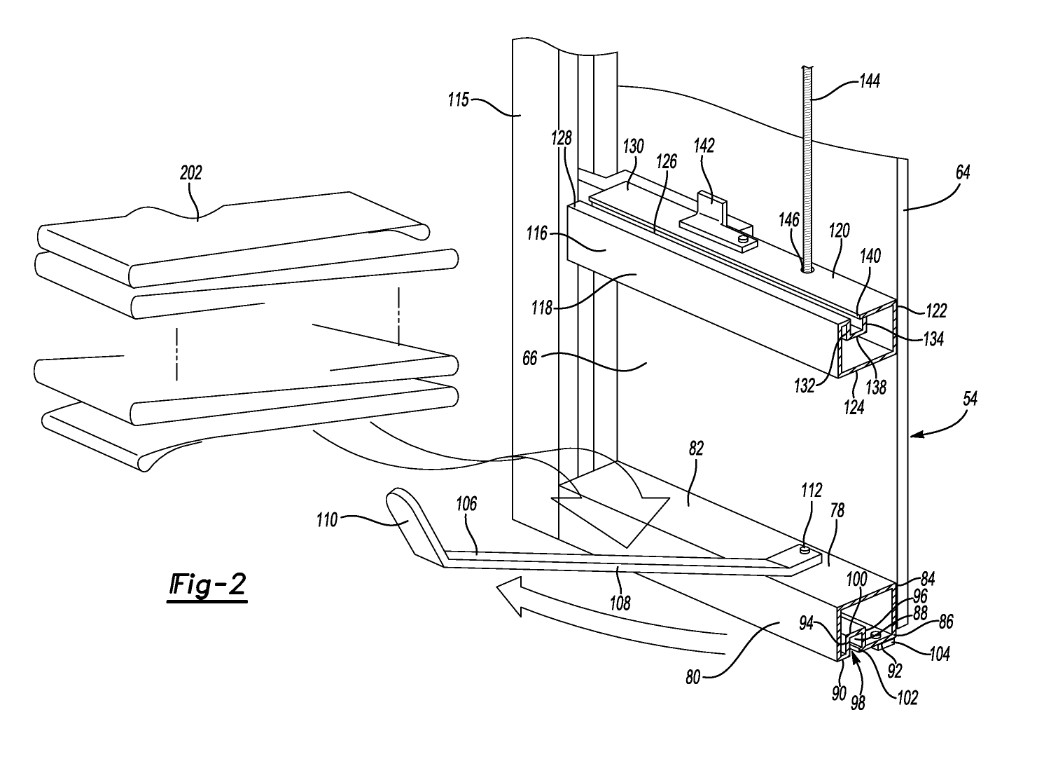

The system 50 may or may not have a center portion 62 bounded by the perimeter 60. In this embodiment, the center portion 62 comprises a plurality of connected panels 64 (See FIGS. 2, 11). However, the invention works equally well with a center portion 62 that is substantially, or entirely, free of panels.

The upper, lower, side portions 52-58 and center portion 62, if any, may be constructed of any materials, which may be by way of example only, wood, plastic, composite materials and/or metal. Preferably, the portions 52-58, 62 are made of metal.

The system 50 has a front side 66 and a rear side 68. The front side 66 is one side upon which advertising material, or copy, may be located. The rear side 68 is opposite the front side 66. Copy may also be located on the rear side 68.

The portions 52-58, 62 may be connected together by a framework 70. The framework 70 typically is located on the rear side 68 of the system 50. The framework 70 comprises a plurality of members that may extend horizontally and/or vertically across the rear side 68. The individual pieces of the framework 70 may themselves be connected together or not. FIG. 1 depicts just one embodiment of the framework 70, other embodiments are permissible.

Looking now at FIG. 1, a base portion 72 is connected to the framework 70 but it may also be connected to any of the other portions. The base portion 72 typically has one or more supports 74 that extend into the ground. The supports 74 function to locate the system 50 a predetermined height above the ground so that the system 50, and its attached advertising material, extends over objects and/or so that it can be seen.

A catwalk 76, shown in FIG. 1, may be attached to the supports 74. The catwalk 76 preferably extends substantially across the front side 66 of the system 50. Typically, the catwalk 76 is located below the lower portion 54 so as not to interfere with the advertising material located on the system 50.

The present invention may also be used without a base portion 72. In these instances, the billboard system 50 may be attached to a vertical surface, such as an exterior building wall. The framework 70 may be used to connect to the building wall so as to suspend the system 50 therefrom.

As shown in FIGS. 1 and 2, the lower portion 54 preferably comprises a lower rail 78. The lower rail 78 may be a single member, or it may be comprised of a plurality of members that have been connected together.

In the depicted embodiment, the lower rail 78 is stationary. Mechanical fasteners and/or welding may be used to attach the lower rail 78 to the system 50. However, the lower rail 78 may be movable, similar to an upper rail that will be described in more detail below.

Looking now at FIG. 2, the lower rail 78 preferably has an outer surface 80, an upper surface 82, a rear surface 84 and a lower surface 86. The outer surface 80, the upper surface 82 and the rear surfaces 84 are substantially planar, with the outer and the rear surfaces 80, 84 being parallel to one another and perpendicular to the upper surface 82. The lower rail 78 may be entirely solid, partially solid or hollow. The rear surface 84 abuts the front side 66 of the system 50.

The lower surface 86 preferably has a continuous channel 88 extending the length of the rail 78. While a continuous channel 88 that extends the length of the rail 78 is preferred, the channel 88 may also be divided into a plurality of segments where the segments may be connected or they may be unconnected. The channel 88 may be integrally formed from and unitary with the lower rail 78.

The channel 88 divides two lands 90, 92 on the lower surface 86. The division may be equal or unequal. A first leg 94 and a second leg 96 extend inwardly into the rail 78 from the lands 90, 92. The legs 94, 96 are preferably parallel to one another and perpendicular to the lands 90, 92. The legs 94, 96 preferably terminate at the same predetermined distance from the lands 90, 92 in an interior portion 98 of the lower rail 78. The legs 94, 96 may also terminate at different distances from their respective lands 90, 92. A bridge 100 connects the two legs 94, 96 within the interior portion. 98

The bridge 100 and the two legs 94, 96 form the channel 88, which is C-shaped. The C-shape may be defined by 90 degree angles between the bridge 100 and the legs 92, 94, or the transitions between the legs 92, 94 and the bridge 100 may have a radius. The C-shape preferably opens downward.

In an embodiment, the second leg 96, which is behind the first leg 94, may have a lip 102 that extends into the channel 88. The lip 102 may be such as an extension from the second land 92. The lip 102 may be unitary with the second leg 96 or it may be separately attached.

As shown in FIGS. 1, 2 and 9, a plurality of channel locks 104 is located on one of the two lands 90, 92 on the lower surface 86. In the depicted embodiment, the locks 104 are located on the second land 92. The locks 104 are pivotally attached to the second land 92. When a lock 104 is pivoted toward the first land 90, it extends at least partially over the channel 88. The lock 104 may extend entirely across the channel 88. The lock 104 is also permitted to pivot entirely clear of the channel 88 such that it resides entirely over the second land 92.

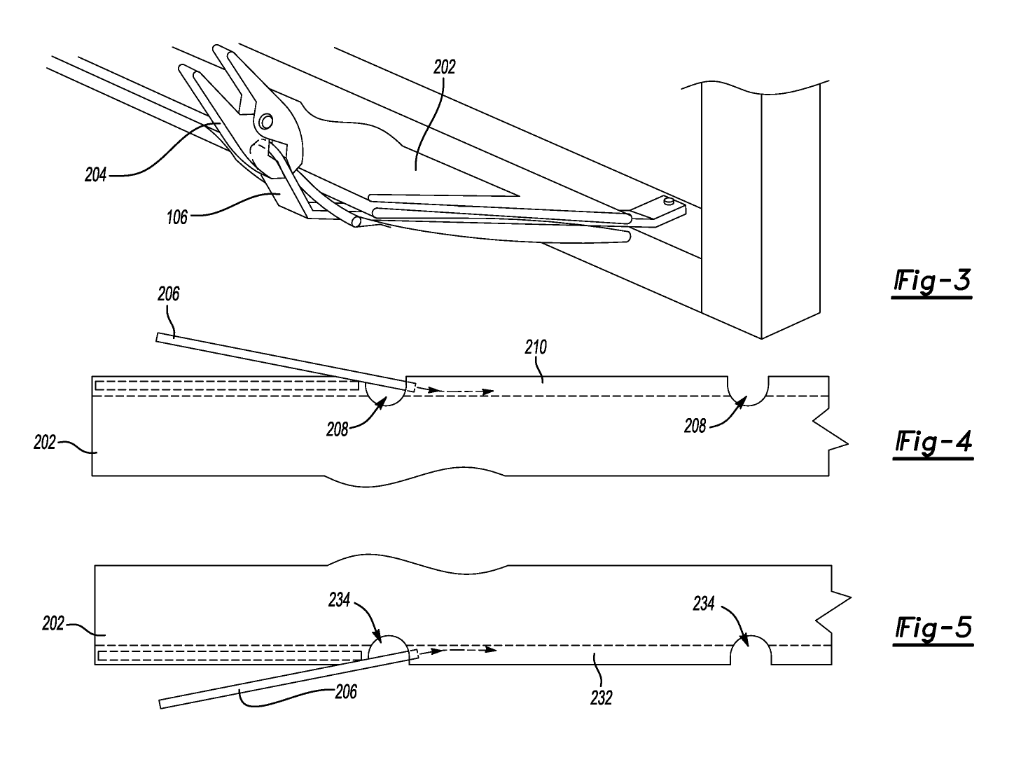

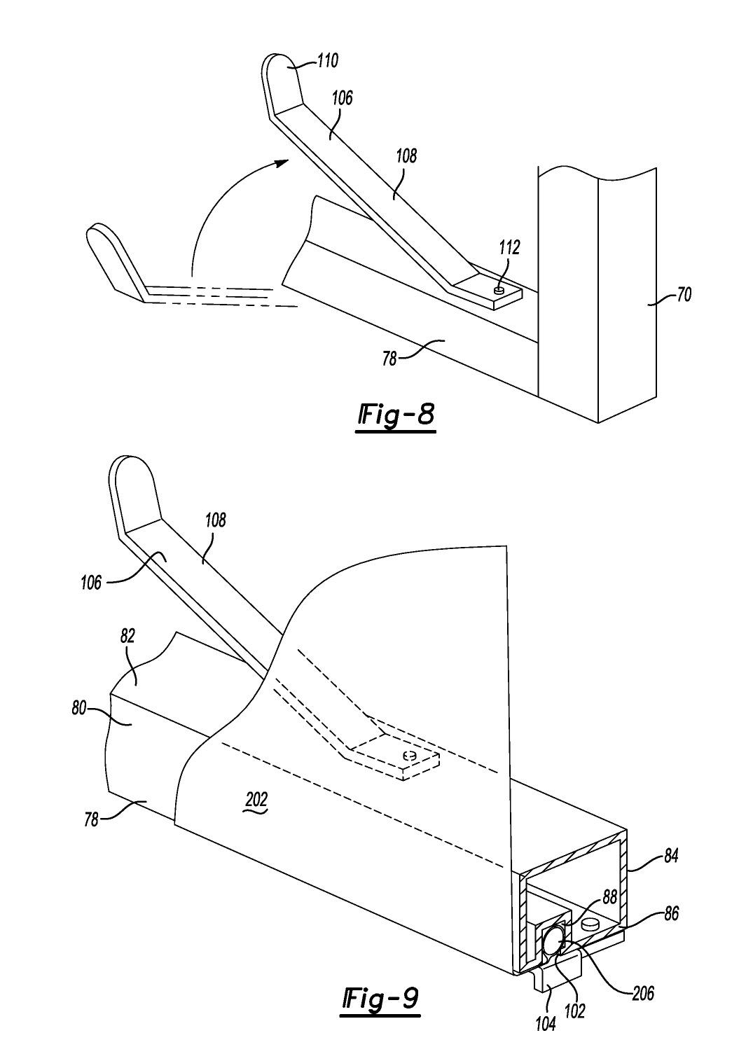

FIGS. 2, 3, 8 and 9 depict one embodiment of a plurality of support arms 106 preferably attached to the upper surface 82 of the lower rail 78. The support arms 106 may have a first portion 108 and a second portion 110. The first portion 108 may be pivotally connected to the upper surface 82 with a mechanical fastener 112. The fastener 112 permits the support arm 106 to rotate from 0 to 180 degrees, with 90 degrees being substantially perpendicular to the outer surface 80. In the 0 or 180 degrees position, the support arm 106 resides substantially entirely over the upper surface 82 of the lower rail 78.

The second portion 110 is unitary with the first portion 108. The second portion 110 may extend away from the upper surface 82 of the lower rail 78 at the same angle as the first portion 108, or it may extend away at a different angle, such as depicted in the figures.

Looking now at FIG. 1, it may be seen that the side portions 56, 58 may be comprised of a first side rail 114 on the first side portion 56 and a second side rail 115 on the second side portion 58. The side rails 114, 115 are substantially similar, and may be identical to one another. Each side rail 114, 115 may be one piece or each may be comprised of a plurality of sections that have been joined together. The side rails 114, 115 are connected to the framework 70 of the system 50 and are not movable. The side rails 114, 115 extend substantially perpendicularly from the lower rail 78.

FIGS. 1, 2, and 6 depict a movable upper rail 116 that also comprises part of the system 50. The upper rail 116 may be a single member, or it may be comprised of a plurality of members that have been connected together. The upper rail 116 extends across at least one panel 64. Preferably, the upper rail 116 extends across the system 50 substantially parallel to the lower rail 78 and substantially perpendicular to the side rails 114.

Preferably, the upper rail 116 substantially extends from the first side rail 114 to the second rail 115. The upper rail 116 may be slidingly located within the side rails 114, 115 or simply adjacent the rails 114, 115.

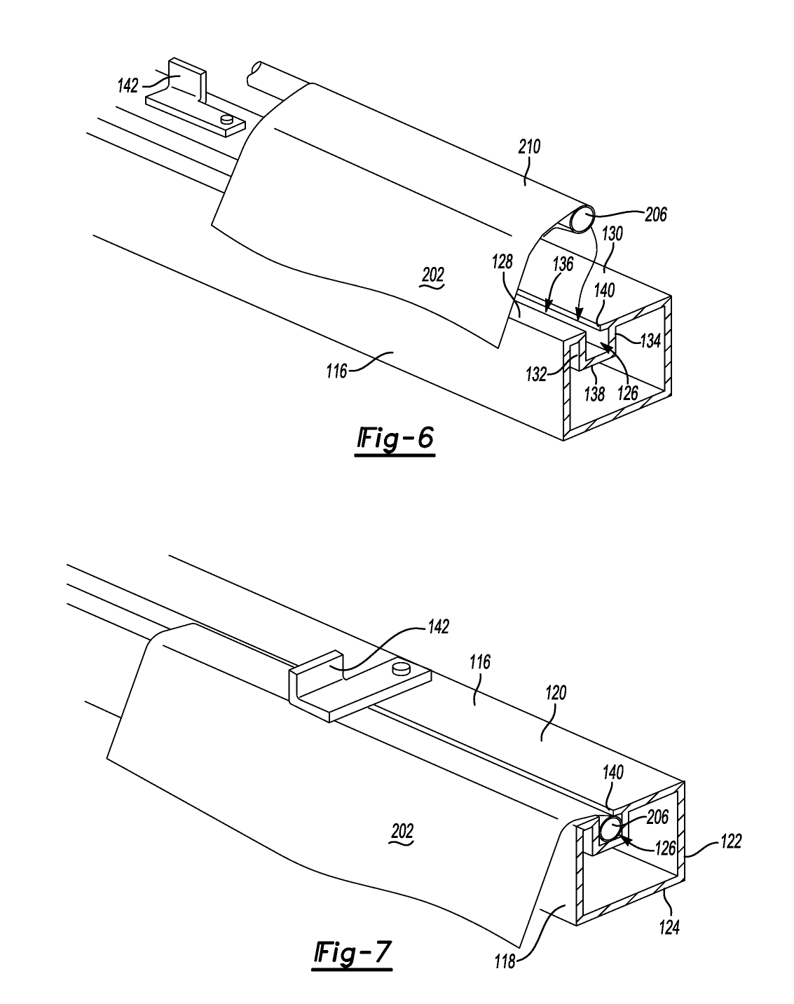

As shown in FIGS. 2 and 6 the upper rail 116 has an outer surface 118, an upper surface 120, a rear surface 122 and a lower surface 124. The outer surface 118, the lower surface 124 and the rear surface 122 are substantially planar with the outer and the rear surfaces 118, 122 being parallel to one another and perpendicular to the lower surface 124.

The upper surface 120 preferably has a continuous channel 126 extending the length of the rail 116. While a continuous channel 126 that extends the length of the rail 116 is preferred, the channel 126 may also be divided into a plurality of segments where the segments may be connected or they may be unconnected.

The channel 126 divides a first land 128 and a second land 130 on the upper surface 120. The division may be equal or unequal. A first leg 132 and a second leg 134 extend inwardly into the rail 116 from the lands 128, 130. The legs 132, 134 are preferably parallel to one another and perpendicular to the lands 128, 130. The legs 132, 134 preferably terminate at the same predetermined distance from the lands 128, 130 in an interior portion 136 of the upper rail 116. The legs 132, 134 may also terminate at different distances from their respective lands 128, 130. A bridge 138 connects the two legs 132, 134 within the interior portion 136.

The bridge 138 and the two legs 132, 134 are designed to create a C-shaped channel 126. The C-shape may be defined by 90 degree angles between the bridge 138 and the legs 132, 134, or the transitions between the legs 132, 134 and the bridge 138 may have a radius. The C-shape preferably extends upwardly.

In an embodiment, the second leg 134, which is behind the first leg 132, may have a lip 140 that extends into the channel 126. The lip 140 may be such as an extension from the second land 130. The lip 140 may be unitary with the second land 130 or it may be separately attached.

Preferably, a plurality of channel locks 142 is located on one of the two lands 128, 130 on the upper surface 120. In the depicted embodiment, the locks 142 are located on the first land 128. The locks 142 are pivotally attached to the first land 128. When a lock 142 is pivoted toward the second land 130, it extends at least partially over the channel 126. The lock 142 may extend entirely across the channel 126. The lock 142 is also permitted to pivot entirely clear of the channel 126 so that it resides entirely over the first land 128.

At least one cable 144 is attached to the upper rail 116, as shown in FIGS. 1 and 2. Preferably, a plurality of cables is attached to the upper rail 116. When a plurality of cables is used, they may be attached substantially equidistantly across the upper rail 116 from one another. The cables 144 may be attached to the upper rail 116 by a variety of structures with the present invention being limited to none of them. By way of example only, and as shown in FIG. 2, an aperture 146 may be located through the upper surface 120 of the rail 116. The cable 144 may be inserted through the aperture 146 and the loose end of the cable 144 may then be prevented from being pulled back through the aperture 146 by locating a mechanical fastener (not shown) on the end of the cable 144. The mechanical fastener has a larger diameter than the aperture 146.

Each cable 144 extends substantially perpendicularly from the upper rail 116 to the upper portion 52 of the system 50. As seen in FIGS. 1 and 10, the upper portion 52 of the system 50 may be comprised of a structural member 148 that comprises part of the perimeter 60 of the system 50.

A plurality of pads 150 is located at predetermined locations on the upper structural member 148, as shown in FIG. 1. More particularly, a pad 150 is located at each location where the cable 144 extends to the upper structural member 148. The vertically extending cable 144 is turned 90 degrees and lies within a channel 152 in each pad 150, as shown in FIGS. 10 and 11. The channel 152 is wide enough to permit the cable 144 to slide forward and rearward but permits little if no side to side movement. The pads 150 are constructed of a resilient material capable of withstanding repeated forward and rearward movement of the cable 144 within the channel 152 while a load is applied to the cable 144. Pads 150 are depicted in the preferred embodiment, but other structures, such as pulleys may be used.

Where more than one cable 144 is used, the cables 144 are consolidated in a common area of the system 50 after they extend through the pads 150. For example, the cables 144 may be located behind the upper structural member 148. From the upper structure member 148, each cable 144 may extend downwardly and adjacent the rear side 68 of the system 50, as shown in FIG. 11. One or more pulleys 151 may assists in directing the each cable 144.

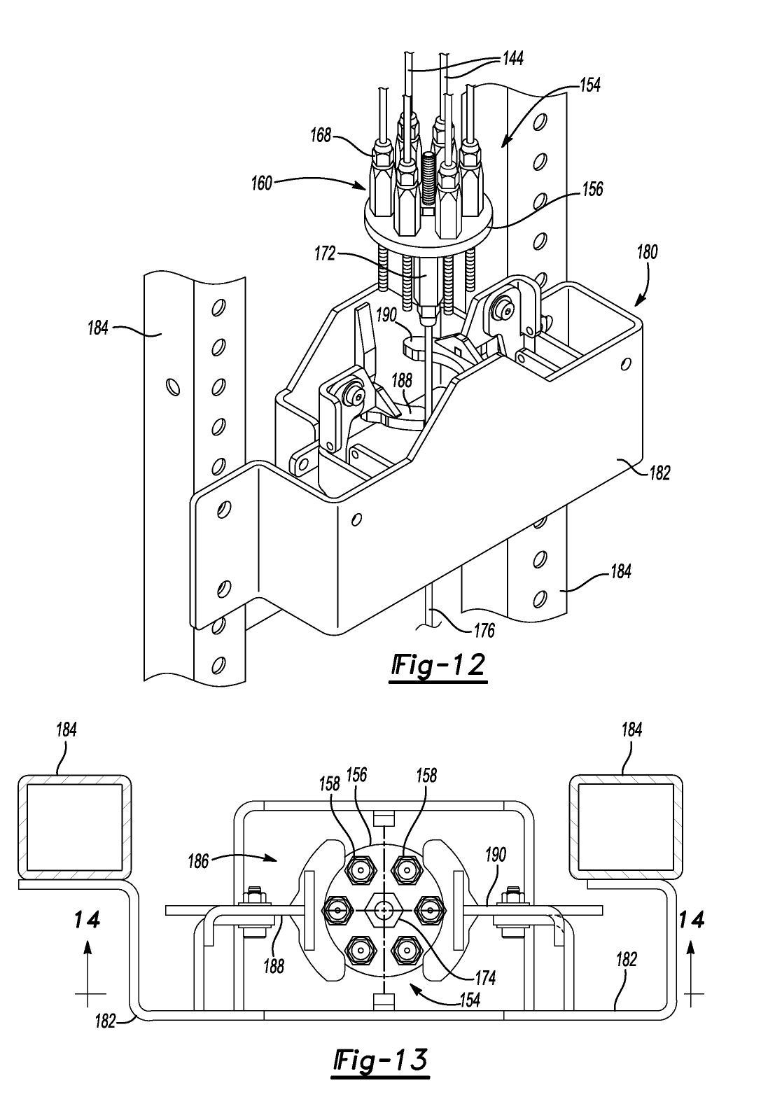

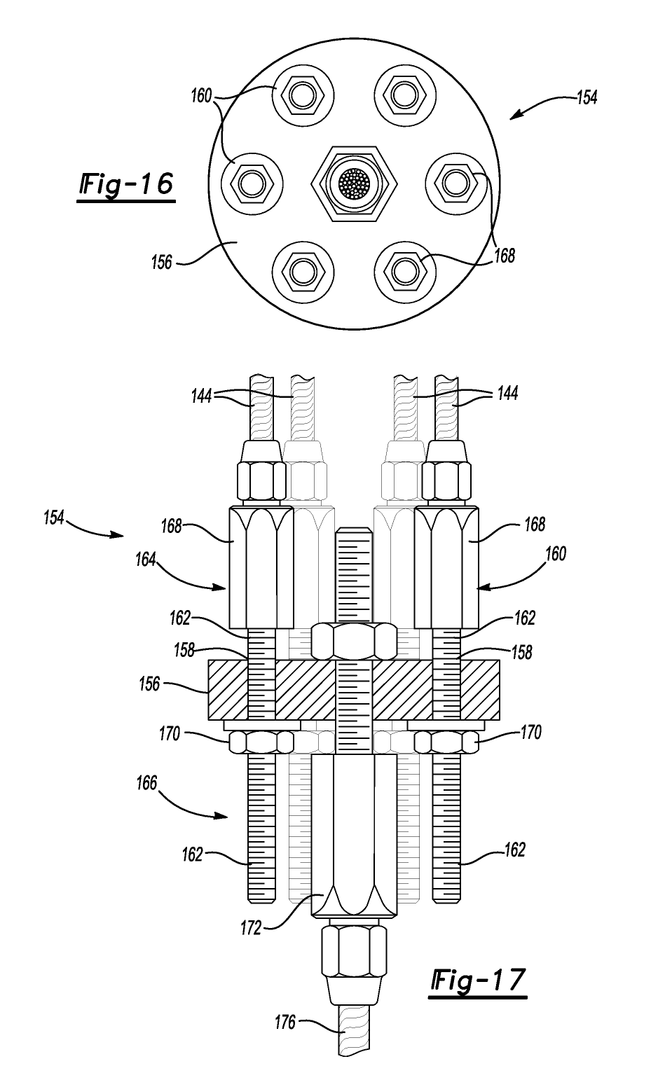

Each cable 144 terminates in a rail leveler 154 as best seen in FIGS. 11 and 12. The rail leveler 154 comprises a plate 156 with a plurality of apertures 158 extending through the plate 156. The apertures 158 may be equally spaced in the plate 156 in a circle, which can be appreciated from FIGS. 13 and 16.

The end of each cable 144 is fitted with a fine adjustment fitting 160 into which the cable 144 is secured, as shown in FIG. 17. The fine adjustment fitting 160 comprises a body 162 with a threaded outer diameter. The body 162 extends through one of the apertures 158 in the plate 156 so as to divide the body 162 into an upper portion 164 and a lower portion 166. A first nut 168 is located on the threads of the upper portion 164 and a second nut 170 is located on the threads of the lower portion 166. By loosening the two nuts 168, 170 and permitting the body 162 to extend from or retract into each of the apertures 158, minute adjustments may be made in the length of each cable 144 extending from the fine adjustment fitting 160 to the upper rail 116. The upper rail 116 is leveled across the first side 66 of the system 50 in this manner.

Another fine adjustment fitting 172, of similar construction, but physically larger to accommodate the combined load of the cables 144 going into the rail leveler 154, is located through a central aperture 174 in the plate 158. Preferably, this fine adjustment fitting 172 is located upside down with respect to the other fine adjustment fittings 160 so that a single main cable 176 extends from the fine adjustment fitting 172 downward to a winch system 178.

The rail leveler 154 may be selectively retained by a latching system 180. One embodiment of the latching system 180 is depicted in FIGS. 11-13. The latching system 180 is designed to selectively engage the rail leveler plate 156 to prevent it from moving upward beyond the latching system 180, thus lowering the upper rail 116, except when specifically desired.

The latching system 180 may comprise a cross bracket 182 that extends from one frame member 184 to another frame member 184 on the rear side 68 of the billboard system 50. The cross bracket 182 may be secured to the frame members 184 such as through a plurality of mechanical fasteners (not shown).

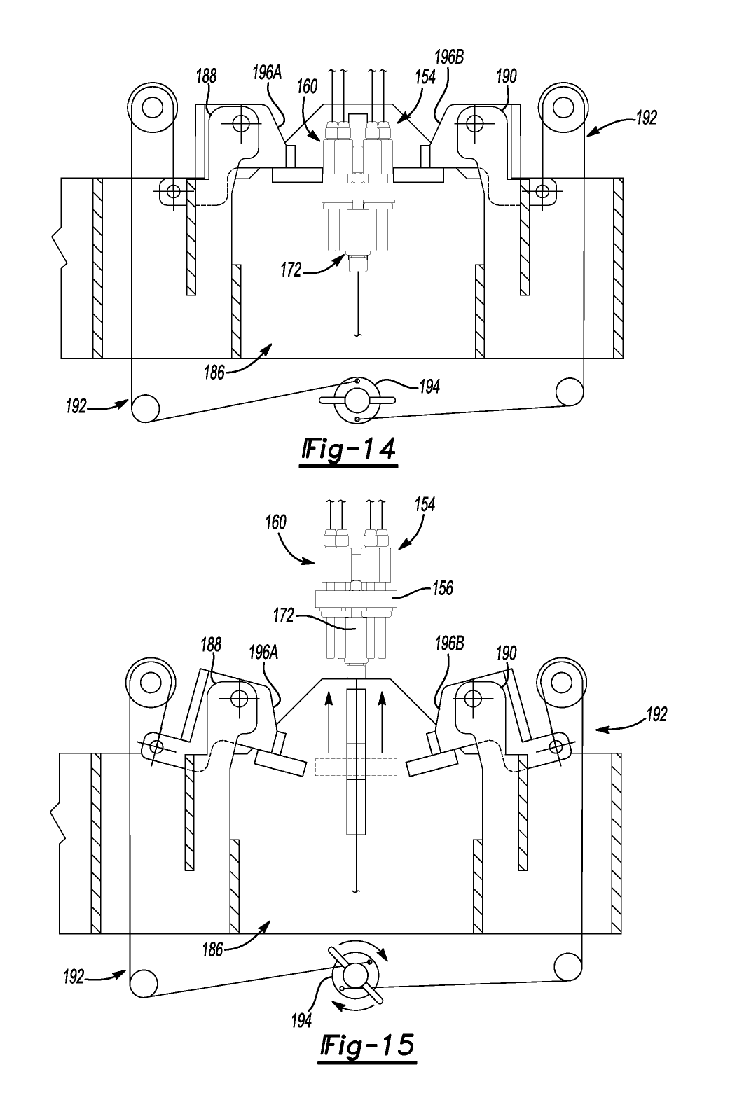

The cross bracket 182 preferably defines an opening 186 in which the rail lever plate 156 may pass through. A first catch 188 and a second catch 190 are pivotally attached to the bracket 182 on either side of the opening 186. The catches 188, 190 may be both connected to a linkage 192 that terminates in a handle 194, as shown in FIGS. 14 and 15. The handle 194 is preferably accessible from the catwalk 76 on the front side 66 of the billboard system 50.

When the handle 194 is moved in a first direction, it causes the catches, 188, 190 through the linkage 192, to pivot away, or open away, from the rail leveler plate 156. With the catches 188, 190 out of the way, the rail leveler plate 156 may move in the vertical direction, which permits the upper rail 116 to lower, as shown in FIG. 15. When the catches 188, 190 are in place, they engage the rail leveler plate 156 and prevent it from moving in the upward vertical direction as shown in FIGS. 13 and 14.

The catches 188, 190 may have angled upper surfaces 196. The angled upper surfaces 196A, 196B slidably engage the rail leveler plate 156 when the plate 156 is moving in the downward vertical direction. As the plate 156 continues downwardly, the plate 156 pushes the catches 188, 190 apart until the plate 156 slides past the angled upper surfaces 196A, 196B. Once the plate 156 is past the angled upper surfaces 196A, 196B, the catches 188, 190 prevent it from moving in the upward vertical direction unless they are released. The latching system 180 will permit the plate 156 to continue to move in the downward direction.

The winch system 178 is preferably located beneath the lower rail 78 and accessible from the front side 66 of the system. More particularly, the winch system 178 is oriented so that it is readily accessible from the catwalk 76. In the depicted embodiment, the winch system 178 is located in a middle portion 198 of the system 50, however, the system 50 may be designed so that the winch system 178 is to one side or the other of the middle portion 198.

As shown in FIGS. 1 and 11, the winch system 178 may be such as a manually rotated winch, an entirely automatic, motor driven winch or a combination of both. The main cable 176 from the rail leveler 154 is wound about a winch drum 202 so that the upper rail 116 may be selectively raised and lowered via the above-described system of fine adjustment fittings, plates and cables 160, 172, 156, 144, 176.

A method of using the system 50 is outlined in FIG. 24. The method initially comprises providing a sheet, or copy 202, of material desired to be located on the system 50. The copy 202 may have various words, slogans, images and the like printed or otherwise located thereon. The copy 202 material itself may be such as vinyl material of sufficient thickness and resilience to withstand most weather conditions and the tensioning step described in more detail below. Vinyl also may be readily recycled.

The copy 202 preferably has approximately the same shape and approximately the same size as the perimeter portion 60 of the system 50. Thus, in the depicted embodiment, the copy 202 is substantially rectangular having two opposed side portions and top and bottom portions. In one embodiment, the copy 202 is provided with pockets along the side and the top and bottom portions. More particularly, at least one pocket is formed in each of the side portions and the top and bottom portions. In the depicted embodiment, a plurality of pockets are provided in each portion. The pockets are integrally formed from the copy 202 and unitary therewith, but they may also be separately attached. The pockets preferably extend the length of the sides and the top and bottom portions. The pockets may be in segments with openings between them.

As will be described below, the present invention works equally well with copy 202 that only has pockets in certain portions or that has no pockets at all. The foregoing, as well as the following, description applies equally to each of these embodiments, except where stated otherwise.

Typically, the copy 202 is provided in a folded form to save space during transport to the site of the system 50. At the system 50, the copy 202 is located onto the support arms 106 and then, as shown in FIG. 2, unfolded onto the support arms 106. One or more clamps 204 may be used to secure the copy 202 to the support arms 106. The copy 202 may extend the length of the lower rail 78 or any fraction thereof. The upper rail 116 is preferably lowered so that it is located adjacent the lower rail 78.

In one embodiment, depicted in FIG. 4, a length of material 206 is located through one of the openings 208 so that the material 206 extends into the top pocket 210. The length of material 206 may be such as an open or solid pipe 206 or rod. Preferably, the pipe 206 is rigid such that it can be pushed through the pocket 210. Lengths of pipe 206 are inserted into the pockets 210, via the openings 208, until the top pocket 210 is substantially filled with lengths of pipe 206 extending end to end. The pipe 206 may be a single piece, it may be pieces connected together or it may be many pieces that are not connected.

Both the pocket 210 and the pipes 206 are located in the channel 126 in the upper rail 116, as shown in FIGS. 6 and 7. The width and the depth of the channel 126 are predetermined so that the pipes 206, encased in the pocket 210, are maintained within the channel 126. The lip 140 may assist in retaining the pipes 206 and copy 202 within the channel 126. The channel locks 142 are pivoted over the channel 126 to effectively lock the pipes 206 and pocket 210 within the channel 126, as shown in FIG. 7.

In another embodiment the copy 202 may be simply wrapped around the pipe 206 without the pipe 206 being located within the pocket 210 whether or not the pocket is present. The pipe 206 and wrapped copy 202 may be located with the channel 126 and the channel locks 142 are pivoted over the two to retain them within the channel 126. This method may be used for the upper rail 116 and/or the lower rail 78 or neither rail 78, 116.

Regardless of whether the copy 202 is filled with pipes 206, or the copy 202 is wrapped about the pipes 206, the copy 204 extends across the outer surface 118 of the upper rail 116, as seen in FIG. 7. The copy 202 covers the upper rail 116 and is not visible. This results in an aesthetically pleasing installation because the system 50 components are largely hidden by the copy 202.

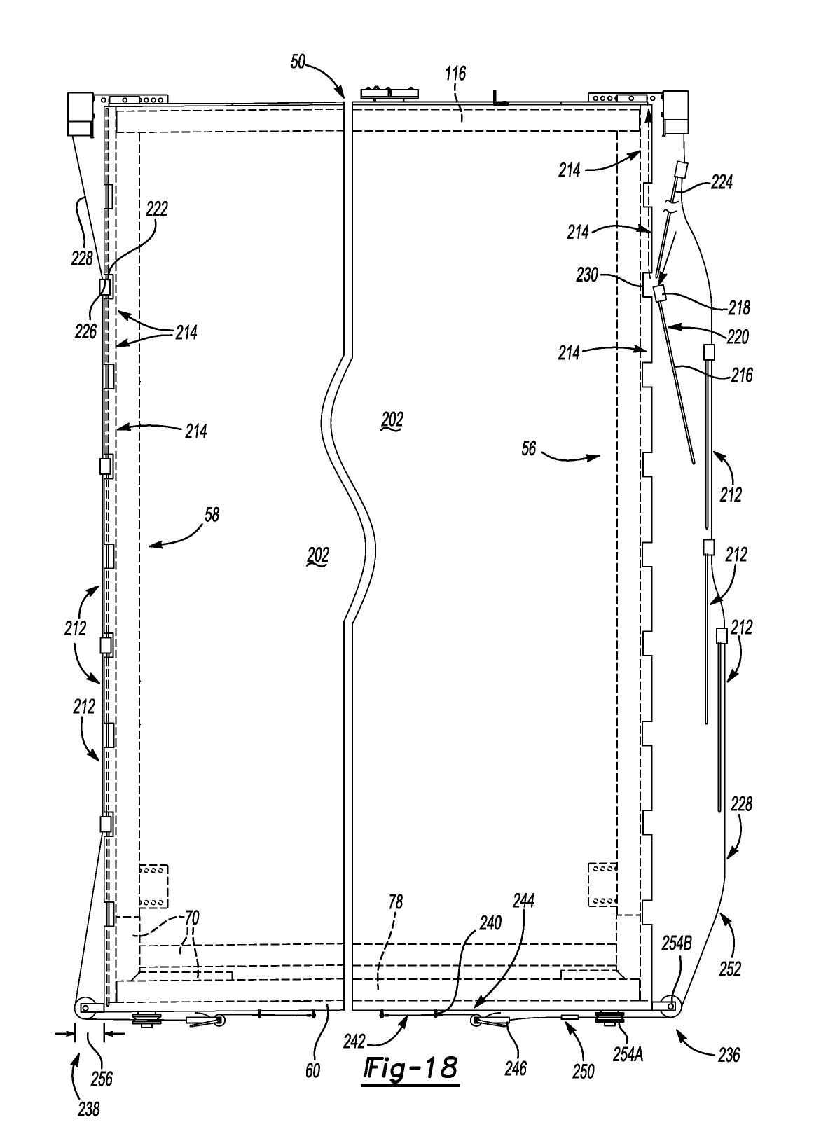

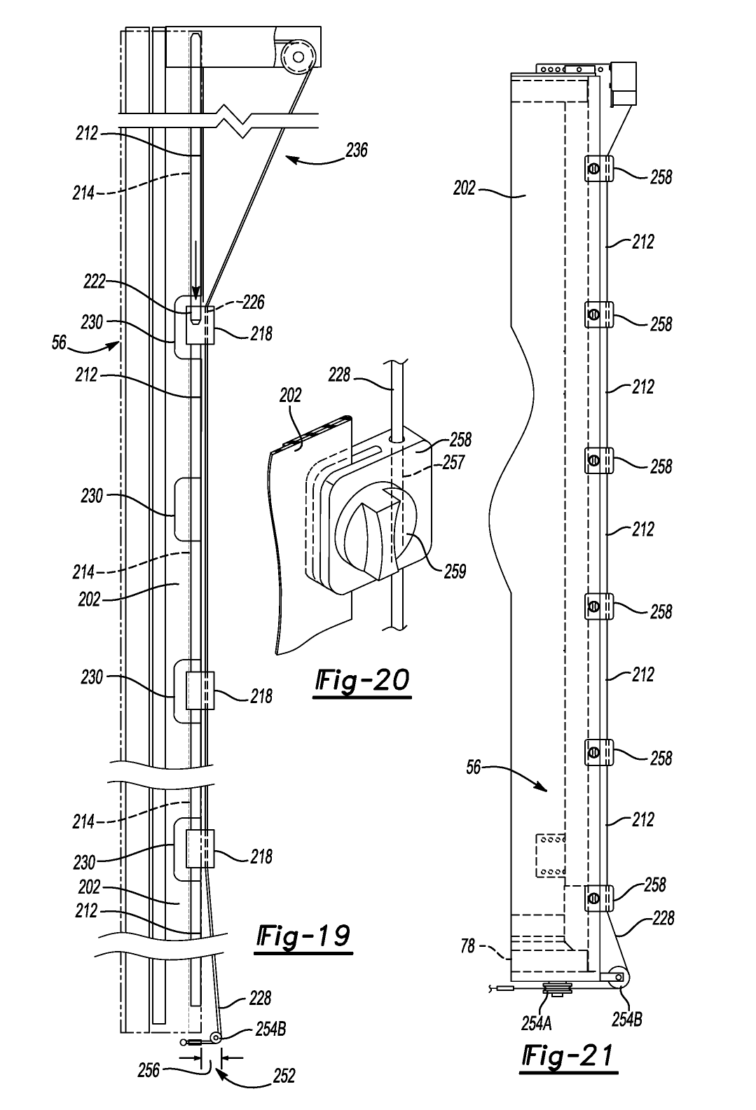

As seen in FIG. 18, open or solid pipes 212 are also located within side pockets 214 on the side of the copy 202. A first pipe 216 is located into one of the side pockets 214 of the copy 202. The first pipe 216 preferably has a connector piece 218 attached to a first end 220 of the first pipe 216. The connector piece 218 has an aperture 222 (see also FIG. 19) for a second pipe 224 to be inserted above the first pipe 216. Additionally, the connector piece 218 has an aperture 226 (see also FIG. 19) for receiving a cable 228 therethrough. The cable 228 extends from a lower portion to an upper portion of the side of the system 50. The connector piece 218 and its associated pipe may slide along the length of the cable 228.

The connector piece 218 extends through a cut out 230 in the side pocket 214. An end of the second pipe 224 is located into the aperture 222 of the connector piece 218. The end abuts the first pipe 216 in the aperture 222 or it may contact a stop in the piece 218. The remainder of the second pipe 224 is located into a side pocket 214 above the pocket 214 filled by the first pipe 216.

A plurality of pipes and connector pieces are located on the cable 228. Thus, a second end of the first pipe 216 is located into the connector piece 218 of the next pipe and so forth until the side pocket 214 is substantially filled with pipes that are continuously connected to one another by the connector pieces 218. Another set of pipes, with their corresponding connector pieces, are assembled for the second side pocket in substantially the same way.

The connected pipes 216, 224 and connector pieces 218 form a rigid, unitary unit where the pipes 216, 224 are all axially aligned with one another within the side pocket 214 of the copy 204, as shown on the left hand side of FIG. 18 and in FIG. 19.

Typically, a worker standing on the catwalk installs one or two pipes 216, 224 in the first side pocket 214 and the second side pocket 214. The winch system 180 is engaged to raise the upper rail 116 a few feet so that the next section of empty side pocket 214 is exposed on both sides. In this way, the side pockets 214 are gradually filled with connected pipes 216, 224 as the upper rail 116 is raised, along with the copy 202 attached to it.

As the upper rail 116 approaches the upper portion 52 of the system 50, a bottom pocket 232 of the copy 202, if present, is accessible. The bottom pocket 232 is depicted in FIG. 5. The bottom pocket 232 may be a single continuous pocket or it may be comprised of a plurality of pockets that are connected or not connected. Preferably, the bottom pocket 232 is comprised of a plurality of pockets separated by openings 234 in the copy 202.

A length of material 206 is located through one of the openings 234 so that the material 206 extends into the bottom pocket 232. The length of material 206 may be the same as used for the top pocket 210. Preferably, the pipe 206 is rigid such that it can be pushed through the pocket 232. Lengths of pipe 206 are inserted through openings 234 in the copy 204 into the pocket 232 until the bottom pocket 232 is substantially filled with lengths of pipe 206 extending end to end.

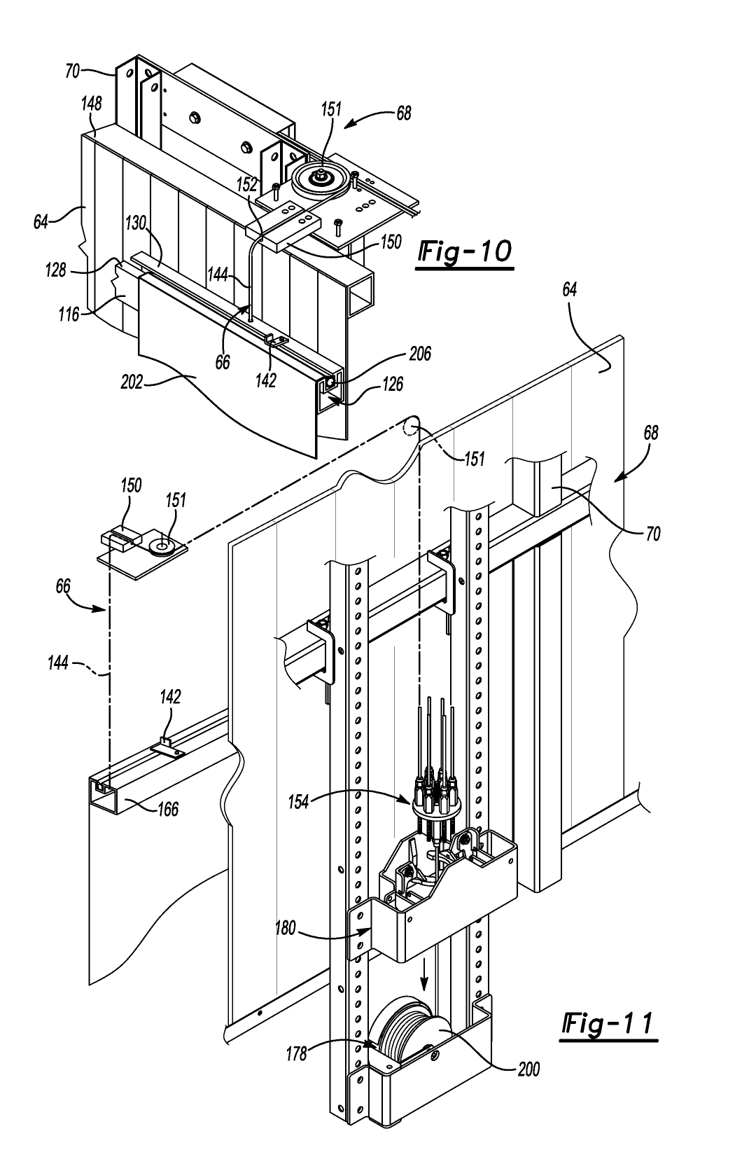

The support arms 106 on the lower rail 78 may be pivoted substantially entirely over the lower rail 78 so that they are no longer perpendicular to the lower rail 78. It will be appreciated from the following that the support arms 106 are covered, or blocked, by the copy 202 that extends over the lower rail 78 so that they are not visible when the copy 202 is fully installed. This feature can be appreciated from FIG. 9.

In one embodiment, both the pocket 232 and the pipes 206 are located in the channel 88 in the lower rail 78 by drawing the copy 202 over the lower rail 78 and into the channel 88, as seen in FIG. 9. The width and the depth of the channel 88 are predetermined so that the pipes 206, encased in the pockets 232, are maintained within the channels 88. The lip 102 may assist in retaining the pipes 206 and the copy 202 within the channel 88. The channel locks 104 are pivoted over the channel 88 to effectively lock the pipes 206 and pocket 232 within the channel 104.

By locating the pipes 206 in their pockets 232 in the channel 88, the copy 202 gets drawn over the outer surface 80 of the lower rail 78. Therefore, the copy 202 covers the lower rail 78 and the lower rail 78 is not visible. This results in an aesthetically pleasing installation because the system 50 components are largely hidden by the copy 202.

Of course, the copy 202 may be located about pipes 206, with or without the pocket, and the copy 202 and pipes 206 may also be located in the channel 188 when the upper rail 116 approaches the upper portion 52.

The winch system 178 is engaged again to raise the upper rail 116 to the upper portion 52 of the system 50. Additionally, the winch system 178 is engaged such that tension is applied to the upper rail 116 via the cables 144. The tension causes the copy 202 stretched between the upper rail 116 and the bottom rail 78 to become taught. The tension in the copy 202 causes it to create a drum-like covering over the perimeter 60 of the system 50 where many, if not all, of the wrinkles in the copy 202 are removed. If the system 50 has a center portion 62 of panels 64, the copy 202 is preferably separated by the panels 64 by a gap (not shown).

A first side tensioning system 236 shown in FIGS. 18 and 19, and a second side tensioning system 238, located on the first and second sides 56, 58, respectively, of the billboard system 50 are used to apply lateral tension to the copy 204. Both systems 236, 238 are substantially the same with respect to one another so the following description of the first side tensioning system 236 applies equally to both side tensioning systems.

A first cable 240 is provided with an inboard end 242 and an outboard end 244. The inboard end 242 is attached to a portion of the perimeter 60.

Preferably, the inboard 242 end is secured to the lower rail 78 or to a lower portion of the framework 70. The outboard end 244 of the cable 240 is connected to a tensioning system, such as hand ratchet, or come-along 246.

Cable 228 is provided with an inboard end 250 and an outboard end 252. The inboard end 250 is connected to the other side of the hand ratchet 246. Cable 228 extends from the ratchet 246, parallel to the lower rail 78 where it then extends through a system of pulleys 254A, 254B on framework 70, as shown in FIG. 18. The system of pulleys 254A, 258B changes the direction of the cable 248 from parallel to the lower rail 78 to perpendicular to the lower rail 78, or parallel to the side rail 56. The system of pulleys 254A, 254B also provides an offset 256 from the side rail 56, as seen in FIGS. 18 and 19. The offset 256 provides an area in which the copy 202 can be drawn into to provide side-to-side tension of the copy 202 on the system 50. The cable 228 also extends through the above-mentioned connector pieces 218.

As the hand ratchet 246 is worked, it adds tension to both the first cable 240 and the second cable 228. The second cable 228 draws the pieces 218, and thus the pipes 216, 224 attached to them, and thus the entire side of the copy 202, evenly toward the first side 56 of the system. More particularly, the side of the copy 202 is drawn rearwardly, or perpendicular, to the front side 66. Thus, the copy 202 makes a turn, such as approximately 90° turn from the front side 66, at the first side 56. Lateral tension is thus applied to the copy 202 in a sufficient manner to remove wrinkles in the copy 202 and cause the copy 202 to form a drum-like orientation with respect to the panels 64 and/or the system 50 overall.

The side tensioning systems 236, 238 apply even tension to the sides of the copy 202 through the linked pipes 216, 224 located in the side pockets 214 of the copy 202. The linked pipes 216, 224 on each side each function as a single unit that moves together as one as the cable 248 located in the connector pieces 218 is tensioned. Typically, the linked pipes 216, 224 all share the same substantially vertical axis when tension is added to the cable 248, as shown in FIG. 19.

The copy 202 may be lowered from the system 50 by reversing the steps described above, thus providing a quick and efficient method of permitting the copy 202 to be lowered for repair or replacement by as few as one worker.

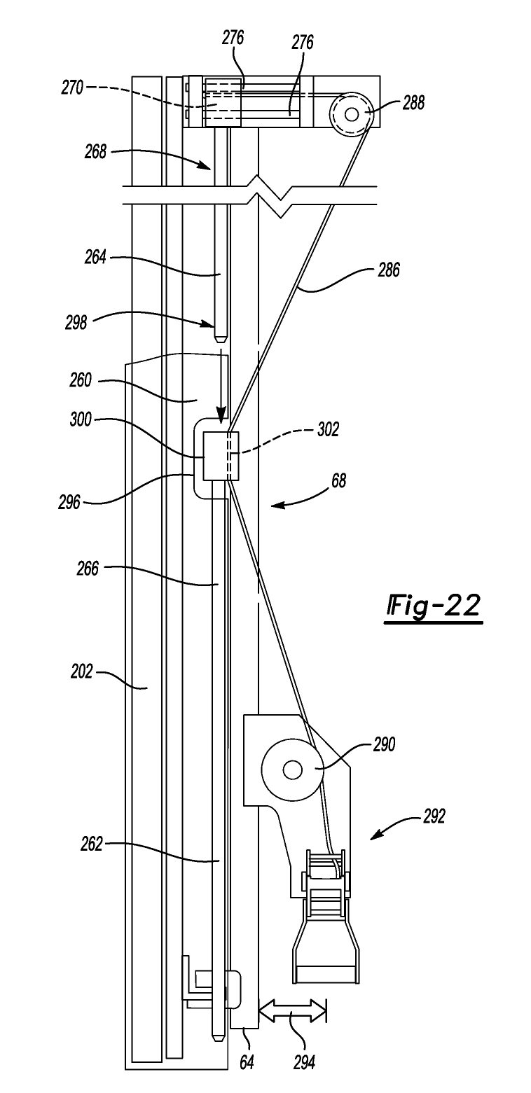

Yet another embodiment of the present invention, depicted in FIGS. 20 and 21, comprises using a plurality of clamps 258 connected to the second cable 228 at predetermined intervals. The clamps 258 may be used in addition to the pipe and connector piece system described above, or entirely separate therefrom. In this embodiment, the clamps 258 may be attached to the side portion of the copy 202 at regular intervals.

The clamps 258 may be of any design. In the depicted design, the clamps have a slot 248 for receiving the copy 202 therein. A knob 259 is turned to tighten the two clamp pieces on either side of the slot 248 onto the copy 202. The cable 228 extends through a channel 257 in the clamp 258 and the clamp 258 may selectively move along the cable 228.

The second cable 228 is drawn tight as described above, thus causing the clamps 258 to draw the attached copy 202 toward both sides 56, 58 of the system 50. Lateral tension is thus applied to the copy 202 to create the same drum-like condition of the copy 202.

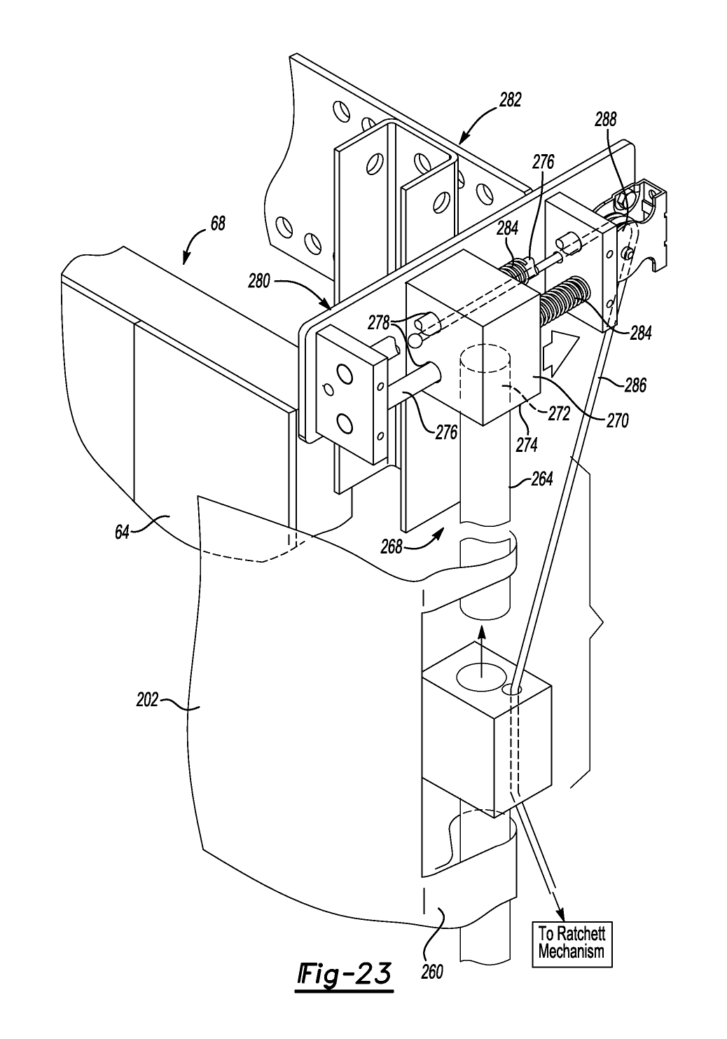

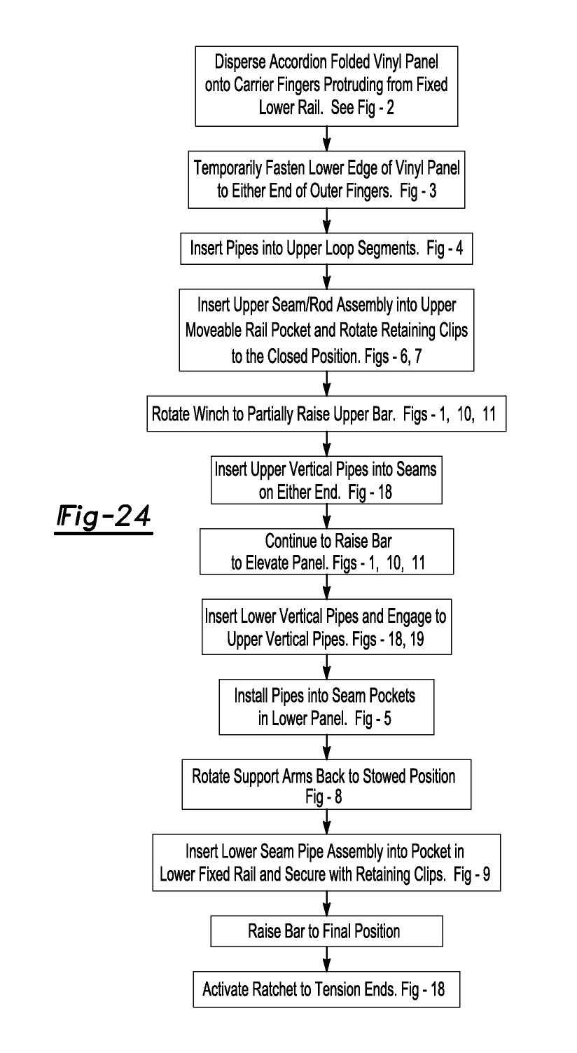

Yet another embodiment of a side tensioning system is provided in FIGS. 22 and 23, where the copy 202 may be provided with two pockets per side portion. If two pockets are provided, one may be an upper pocket 260 and the other may be a lower pocket 262. The upper pocket 260 may be of a greater length than the lower pocket 262.

An upper pipe 264 and a lower pipe 266 are provided. An upper end 268 of the upper pipe 264 is connected to a rod block 270. Preferably, the upper end 268 of the upper pipe 264 is located in an aperture 272 in a lower surface 274 of the rod block 270.

The rod block 270 is connected to at least one block slide 276. The at least one block slide 276 extends in a perpendicular fashion rearward with respect to the panels 64. It is preferred that the rod block 270 is slidably engaged with two block slides 276. The block slides 276 extend entirely through two apertures 278 on the rod block 270. The rod block 270 divides the block slides 276 into a forward portion 280 and a rear portion 282.

The rear portion 282 of each block slide 276 is fitted with a spring 284. In the depicted embodiment, a spring 284 is wrapped about each block slide 276 in a concentric fashion. It can be appreciated that only one concentric spring 284 can be used and/or other biasing means are permissible.

The rod block 270 is thus permitted to selectively slide forward and back along the block slides 276. The rod block 270 is biased forward in the default position by the springs 284.

A cord 286 is secured to the rod block 270. Preferably, the cord 286 extends through the rod block 270 substantially parallel to the block slides 276. The cord 286 extends across a first pulley 288 and then downwardly. The first pulley 288 is offset from the rear side 68 of the panel 64.

The cord 286 then extends to a second pulley 290. The second pulley 290 is also offset from the rear side 68 of the panel 64.

The cord 286 is also connected to a tension system 292, such as a ratchet. The ratchet has an offset 294 from the rear side 68 of the panel 64.

In use, the upper pipe 264 is inserted into the upper pocket 260 of the copy 202 when the copy 202, attached to the upper rail 116 as described above, is raised upwardly. The upper pipe 264 slides into the pocket 260 for a large portion of the copy 202 height.

The upper pipe 264 extends through the upper pocket 260. A window 296 exists in the copy 202 between the upper pocket 260 and the lower pocket 262. A lower portion 298 of the upper pipe 264 can be seen in the window 296.

The lower pipe 266 is inserted into the lower pocket 262. The lower pipe 266 and the upper pipe 264 are joined through a connector piece, as described above. The two connected pipes 264, 266 provide for an axially aligned and continuous structure within the pockets 260, 262. The cord 286 extends through an aperture 302 in the connector piece 300 so that the lower pipe 266 is slidable selectively along the cord 286.

When the ratchet 292 is engaged, the cord 286 is pulled so that the first end of the cord 286 draws the rod block 270 rearwardly along the block slides 276, which compresses the springs 284. At the same time, the cord 286 pulls the connector piece 300 in a rearward direction, thus also drawing the upper pipe 264, and the lower pipe 266, rearward. The uniform rearward movement of the two rods 264, 266, and thus the copy 202 attached to it, results in uniform side-to-side tension being added to the copy 202. The side-to-side tension causes the copy 202 to become taught thus removing wrinkles and causing the copy 202 to form a drum-like orientation with respect to the panels 64.

In addition to the connector piece 300, or separate therefrom, the cord 286 may extend through a clip (not shown). The clip may be such as a carabiner. The clip is selectively secured to the upper pipe 264 approximately one half to two thirds down the pipe 264. The clip may be loosely engaged with the pipe 264 so that the pipe 264 is permitted some vertical movement but it is sufficiently engaged to draw the pipe 264 rearwardly to add side tension to the copy 202.

The two sides of the billboard system 50 may be similarly equipped with the side torsioning system discussed above.

The steps above may be reversed to release side tension on the copy 202 so that the copy 202 can be lowered and removed from the system 50.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A billboard system, comprising:
a framework supporting at least one panel;
a lower rail immovably fixed to a lower portion of said framework and extending across said panel, said lower rail having at least one downwardly opening channel for receiving a first portion of a billboard copy therein;
an upper rail movable with respect to said framework, said upper rail extending across said panel, said upper rail having at least one upwardly opening channel for receiving a second portion of said billboard copy therein;
at least one tab on both said lower rail and said upper rail, said tabs being selectively pivotable between a forward facing position and a side facing position at least partially across said channels.

2. The system of claim 1, wherein said upper channel and said lower channel are located between two lands of each of said rails and said tabs being pivotally mounted on lands closest to said panel.

3. The system of claim 1, wherein a plurality of tabs is spaced along each of said rails.

4. The system of claim 1, wherein in said forward facing position, said at least one tab secures a rod selectively located in said channel.

5. The system of claim 1, wherein said channels are each located within and unitary with said rails and each comprise four sides with two parallel legs, a bridge substantially perpendicular to said legs and an open side.

6. The system of claim 5, wherein one of said legs has a lip at least partially extending into said channel.

7. The system of claim 1, wherein said lower rail has an upper surface, an outer surface, a lower surface and a rear surface, wherein said channel is located in said lower rail lower surface and said upper rail has an upper surface, an outer surface, a lower surface and a rear surface, wherein a channel is located in said upper rail upper surface.

8. The system of claim 1, wherein at least one arm is connected to said lower rail to selectively pivot between an extended position substantially perpendicular to said lower rail and a stored position substantially parallel to said lower rail.

9. The system of claim 7, wherein said billboard copy has an upper portion, a lower portion and at least one side portion, wherein said upper portion and said lower portion each selectively receive at least one rod, said portions and said rods being selectively located within said respective channels so that said copy extends across said outer surfaces of said respective rails.

10. The system of claim 9, wherein pockets in said upper and lower portions of said copy receive a plurality of rods, said pockets being unitary with said copy.

11. The system of claim 10, wherein said rods and pockets in said channels are at least flush or recessed with lands on either side of said channel.

12. The system of claim 9, wherein said copy extends over outer lands of said rails and not inner lands of said rails.

13. A billboard system, comprising:
at least one panel;
a framework supporting said at least one panel; and
a billboard copy for at least partially covering said at least one panel, said copy having an upper portion, a lower portion and at least one side portion, wherein said at least one side portion selectively receives at least two rods selectively connected to one another; and
a side portion tensioning system comprising a rod block slidably mounted on at least one block slide, said block slide biased by at least one spring on said block slide, and a first rod extending down from said rod block to connect with said copy.

14. The system of claim 13, wherein said at least one side portion comprises at least one unitary pocket.

15. The system of claim 14, wherein said first rod is located in a first pocket and a second rod is located in a second pocket, said first and second rods being selectively connectable to one another with a connector piece located between said pockets and said rods.

16. The system of claim 15, wherein said first and second rods in said pockets and connected to one another are axially aligned.

17. The system of claim 15, wherein a first end of a cord is connected to said slide block, a second end of said cord is connected to a ratchet and a middle portion of said cord is attached adjacent said two rods.

18. The system of claim 17, wherein said block slide is oriented transverse to said two rods and said at least one panel.

19. A billboard system, comprising:
at least one panel having a front side and a rear side;
a framework supporting said at least one panel;
a rail movable along said front side of said at least one panel, said rail selectively receiving a portion of a billboard copy therein;
at least two rail cables connected to said rail, said cables extending at least partially across said front side and at least partially across said rear side of said at least one panel;
upper cable length adjusters connecting said at least two rail cables extending across said rear side to a rail leveler; and
at least one lower cable length adjuster connecting said rail leveler to a cable moving system.

20. The billboard system of claim 19, wherein said upper cable length adjusters and said lower cable length adjuster are threadably engaged with said rail leveler.

21. The billboard system of claim 19, further comprising a latching system for selectively engaging said rail leveler on said rear side.

22. The billboard system of claim 21, wherein said latching system comprises a cross bracket defining a rail leveler opening therein.

23. The billboard system of claim 22, wherein said latching system comprises at least one rail leveler catch for selectively engaging said rail leveler.

24. Tensioning a billboard system, comprising:
providing at least one billboard panel with an upper portion, a lower portion, at least one side portion a forward portion and a rear portion;
connecting a side portion of a billboard copy to at least one side rod;
locating at least one upper rail rod in an upper rail channel and locating at least one lower rail rod in an immovable lower rail channel, said billboard copy connected to both said upper rail rod and said lower rail rod;
raising said upper rail channel with a cable to add vertical tension to said billboard copy; and
drawing said at least one side rod connected to said billboard copy rearwardly beyond said billboard panel side portion to add horizontal tension to said billboard copy.

25. The method of claim 24, wherein an upper side rod is located within a first pocket in said side portion of said copy, a lower side rod is located within a second pocket in said side portion of said copy and said two rods are connected together.

26. The method of claim 25, wherein said connected upper side rod and said lower side rod simultaneously are drawn rearwardly by a single cord.

27. The method of claim 24, further comprising leveling said upper rail by adjusting the length of individual cords extending from said upper rail to a rail leveler.

28. The method of claim 24, wherein two side rods are provided and said rods maintain axial alignment and remain parallel said billboard panel side portion during said rearward movement.

29. The method of claim 24, wherein said side rod is drawn through its connection to a rod block sliding rearwardly along a block slide.
